(19) United States
(12) Patent Application Publication
(10) Pub. No.: US 2004/0044728 A1
(43) Pub. Date: Mar. 4, 2004

(54) Application program sharing systems, processing devices and application program sharing methods

(76) Inventor: Ullas Gargi, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/232,443

(22) Filed: Aug. 29, 2002

(51) Int. Cl. G06F 15/16

(52) U.S. Cl. 709/203

(57) ABSTRACT

Application program sharing systems, processing devices and application program sharing methods are described. According to one aspect, an application program sharing system includes a host device configured to execute an application program and to depict a first user interface according to a first compilation of a plurality of first interface entities to convey information regarding the execution of the application program, a client device configured to communicate with the host device and to depict a second user interface according to a second compilation of a plurality of second interface entities different than at least some of the first interface entities of the first compilation, and wherein the client device is configured to depict the second user interface to convey information regarding the execution of the application program by the host device, and wherein at least one of the host device and the client device is configured to associate one of the first interface entities with one of the second interface entities, and the associated one of the first user interface entities and the associated one of the second user interface entities comprise different user interface entities.

### FIELD OF THE INVENTION

The invention relates to application program sharing systems, processing devices and application program sharing methods.

### BACKGROUND OF THE INVENTION

Processing devices arranged to process and display information have become commonplace in recent decades. The size of some processing device configurations has continued to decrease as improvements to the devices are made. The new device configurations provide advantages including increased portability. For example, home personal computers or computer workstations have been implemented in laptop or notebook computers providing portable processing devices. More recently, additional portable devices, also referred to as mobile appliances, have been developed and introduced which have reduced size, increased portability, and increased processing capabilities. Pocket or handheld personal computers or personal digital assistants (PDAs), such as the Jornada™ available from Hewlett-Packard Company, are examples of these devices.

Networked and wireless communications have also been utilized to provide increased communications capabilities for portable devices. The portable devices may communicate with networks, servers, personal computers, workstations, or other remotely located equipment using wireless or networked communications in these arrangements. Accordingly, these devices enable a user to access remotely located devices (e.g., a host computer) using wireless communications or other appropriate communications medium.

In some implementations, it may be desirable for the portable or remote device (also referred to as a client device) to remotely access a user interface hosted on a desktop of the host device. High-bandwidth communications may be utilized to communicate screen resolution data from host servers to the remote devices to enable the remote devices to display the user interfaces of the host devices. According to these designs, a large portion of the available bandwidth for communications is utilized to communicate screen update information for the user interfaces instead of providing communications of user data.

Protocols, such as virtual network computing (VNC), have been developed to provide compression and transmission of desktop interfaces from a host computer to a client device (or other computer or appliance). The compression provided by the defined protocols reduces the demands placed upon the available bandwidth for communication of the screen update information for the user interfaces. However, these protocols still provide transmission of full desktop user interfaces typically necessitating the use of high-bandwidth communications.

Representation formats, such as scalable vector graphics (SVG), offer compact or reduced communications. However, these formats are not typically suitable for bitmap graphics and may be difficult to generate dynamically from arbitrary bitmaps.

Aspects of the invention provide apparatuses and methods for facilitating communications between a plurality of devices. Some aspects provide improved apparatuses and methods for sharing application programs and communicating user interfaces and user interface updates between devices. Other aspects are provided and are apparent from the following description and drawings of exemplary apparatuses and methods of the invention.

### SUMMARY OF THE INVENTION

Application program sharing systems, processing devices and application program sharing methods are provided.

According to one exemplary aspect of the invention, a processing device configured to share an application program comprises a communications interface adapted to couple with a remote device, a display configured to depict a first user interface according to a plurality of first interface entities to communicate information to a user regarding an execution of an application program using one of the processing device and the remote device, and wherein the display depicts the first user interface corresponding to a second user interface depicted using the remote device according to a plurality of second interface entities, and processing circuitry configured to control communications with respect to the remote device, to associate one of the first interface entities with one of the second interface entities, and to control the display to depict the first user interface according to the associated one first interface entity.

According to another exemplary aspect, an application program sharing method comprises providing a processing device having a first compilation of a plurality of first interface entities, executing the application program using the processing device, sharing the execution of the application program with a remote device having a second compilation of a plurality of second interface entities, associating one of the second interface entities with one of the first interface entities, and wherein the associated first and second interface entities comprise different interface entities, and depicting a user interface using the processing device to convey information regarding the execution of the application program and according to the first interface entities including the associated one of the first interface entities.

It is apparent from the following description and figures that additional aspects of the present invention are provided.

### DESCRIPTION OF THE DRAWINGS

FIG. 1 is an illustrative representation of a system including a plurality of processing devices arranged to communicate with one another.

FIG. 2 is a functional block diagram of an exemplary configuration of a processing device of the system.

FIG. 3 is a system diagram illustrating exemplary aspects of one of the processing devices.

FIG. 4 is a flow chart illustrating exemplary communications between the processing devices.

### DETAILED DESCRIPTION OF THE INVENTION

As described below and in accordance with exemplary aspects of the present invention, faster communications of user interaction sessions between host and client devices are provided. Low-bandwidth communications of desktop-resolution user interfaces are provided using identifiers and interface entity updates. The low-bandwidth communications permit usage of other available bandwidth for other data, such as audio, video, text, etc. Additionally, upgraded look and feel of the user interfaces of host device and/or client device are possible with minimal use of available bandwidth.

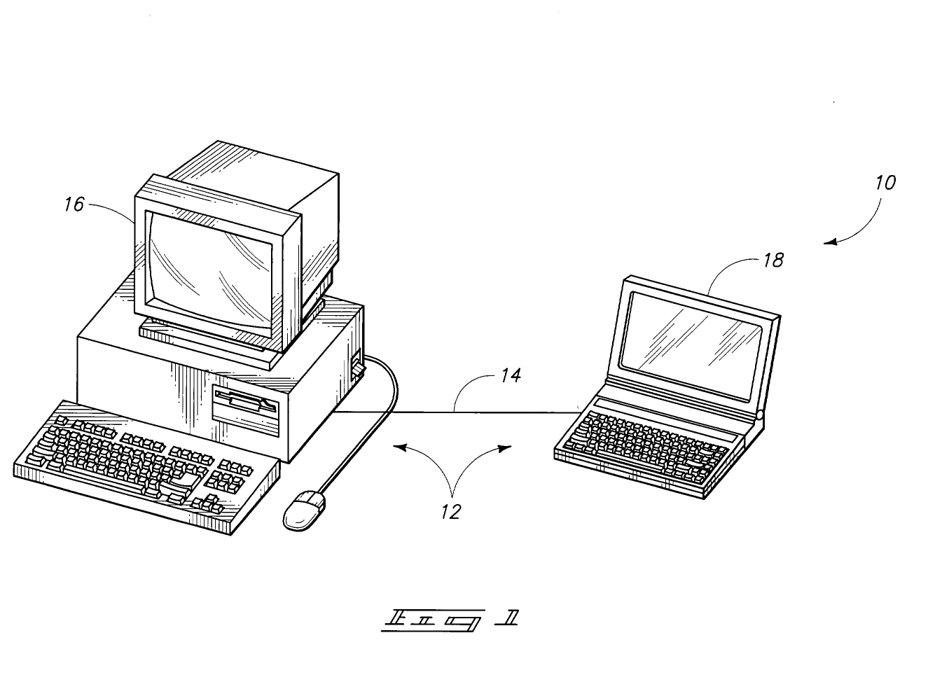

Referring to FIG. 1, an exemplary system 10 including a plurality of processing devices 12 is illustrated. Processing devices 12 are arranged to communicate with one another via an appropriate communications medium 14 including, for example, public and/or private networks. Processing devices 12 may be located in close proximity to one another or spaced apart from one another by considerable distances. Regardless of the distances between processing devices 12, one of the processing devices 12 may be referred to as being remotely located with respect to the other processing device 12. Further, additional processing devices configured to communicate with the illustrated devices 12 may be provided in other arrangements of system 10.

Processing devices 12 are individually configured to communicate information to a user via a respective user interface, such as a graphical user interface (GUI). Exemplary configurations of processing devices 12 include personal computers, workstations, servers, notebook computers, laptop computers, TV set top boxes, mobile appliances (e.g., pocket computers, handheld computers, personal digital assistants (PDAs), cellular telephones, electronic gaming devices, multi-media devices, etc.) or other electronic devices capable of conveying information to users via user interfaces.

In some instances, the user interfaces of the respective processing devices 12 may resemble one another depending upon the particular configurations of the processing devices 12, the operating systems being executed by the processing devices 12 or other criteria. Alternatively, the user interfaces may look drastically different from one another. For example, in the depicted exemplary system 10, processing devices 12 include a host device 16 and a client device 18. If host device 16 is implemented as a personal computer and client device 18 is implemented as a notebook computer which both execute a similar operating system (e.g. WindowsXP™ available from Microsoft Corporation), then respective devices 16, 18 may be arranged to present similar user interfaces (e.g., using a windows environment) to a user. Alternatively, if one of processing devices 12 is implemented as a personal computer, and the other is implemented as a personal digital assistant or cellular telephone, then different user interfaces corresponding to the respective device configurations are presented to the users in some implementations.

According to aspects of the invention, at least one of processing devices 12 of system 10 is arranged to execute an application program (e.g., word processing program, spreadsheet program, etc.). Processing devices 12 are individually arranged to communicate information to one another using medium 14 and regarding the execution of the application program. Additionally, one or more of the processing devices 12 is arranged to communicate information regarding the execution of the application program to a user via a respective user interface. Accordingly, system 10, arranged to implement sharing of information for an executed application program among plural processing devices 12, may be referred to as an application program sharing system.

In one implementation of system 10, the processing device 12 arranged to execute the application program may be referred to as the host device 16 and other processing device(s) 12 may be referred to as client device(s) 18. Host device 16 and client device 18 are arranged to communicate with one another including individually outputting and receiving information regarding the execution of the application program using the host device 16. In the described arrangement, processing devices 12 are arranged to depict respective user interfaces to convey information to a user (including information regarding the execution of the application program within host device 16).

Processing devices 12 are arranged to depict user interfaces according to respective compilations of interface entities. Exemplary user interface entities include events generated by host device 16 upon execution of the application program and which affect the user interface presented to a user. Additional exemplary user interface entities include actions by a user with respect to one of the processing devices 12 which affect the user interface. Exemplary user interface entities may also include visible interface elements (e.g., windows, icons, toolbars, etc.) depicted within the user interface.

As mentioned above, the depicted user interfaces may be depicted according to similar or different formats depending upon hardware configurations of processing devices 12, the operating systems utilized by the respective processing devices 12, or other criteria. For example, host device 16 may include a first compilation of a plurality of interface entities while the client device 18 may include a second compilation of interface entities different than the first compilation of interface entities of the host device 16. According to aspects of the invention, one or more interface entity of a compilation of one of the processing devices 12 may be shared with the compilation of another processing device 12. Sharing of one or more interface entity permits both processing devices 12 to communicate common information (e.g., regarding the execution of the application program) to users via different user interfaces. Additional details regarding sharing of interface entities are described below.

In addition, same, similar or different interface entities of respective user interfaces of host device 16 and client device 18 may be associated with one another to communicate common information to users via different user interfaces. For example, an interface entity action of inputting via a mouse click of one processing device 12 may be associated with a button of another processing device 12 (e.g., typical in configurations of device 12 not having a mouse). An interface entity event of closing a window in a processing device 12 using a Windows™ operating environment may be associated with an interface entity of iconification of a window in the other processing device 12. When possible, it may be desirable to associate the same interface entities with one another for familiarity (e.g., prompting a user using an OK dialog box).

Interface entities comprising visible interface elements of the processing devices 12 may also be associated with one another. For example, a visible window of one processing device 12 may be associated with a three dimensional object of the other processing device 12 which utilizes a three-dimensional user interface. A visible dialog box could be associated with a single frame for text display (e.g., in a processing device 12 comprising a cellular telephone). A visible icon representing a specific audio source (e.g., audio/MP3) in the user interface of one processing device 12 could be represented using a generic icon in the user interface of the other processing device 12. The above-described interface entities are for illustration and for describing exemplary aspects of the invention. Additional interface entities could be associated with one another to convey information, including information regarding the execution of the application program, using plural processing devices 12. Additional details regarding exemplary association procedures of the interface entities are described further below.

As described herein, aspects of the invention provide translation and sharing of user interface entities from one processing device 12 to the other processing device 12 for use in depicting respective user interfaces using the devices 12. State changes (e.g., corresponding to events, actions, or other changes to the user interfaces) of the user interfaces may be implemented by communicating identifiers identifying the interface entities to be modified, and the changes to the identified interface entities (e.g., close window, move window, new text strings, etc.). The other processing device 12 receives the identifiers and the respective changes and implements the changes to the interface entities of the respective user interface. Exemplary implementations of the invention reduce the demands placed upon the communications medium 14 and communications protocol inasmuch as the entire interface entities or entire user interfaces need not be communicated.

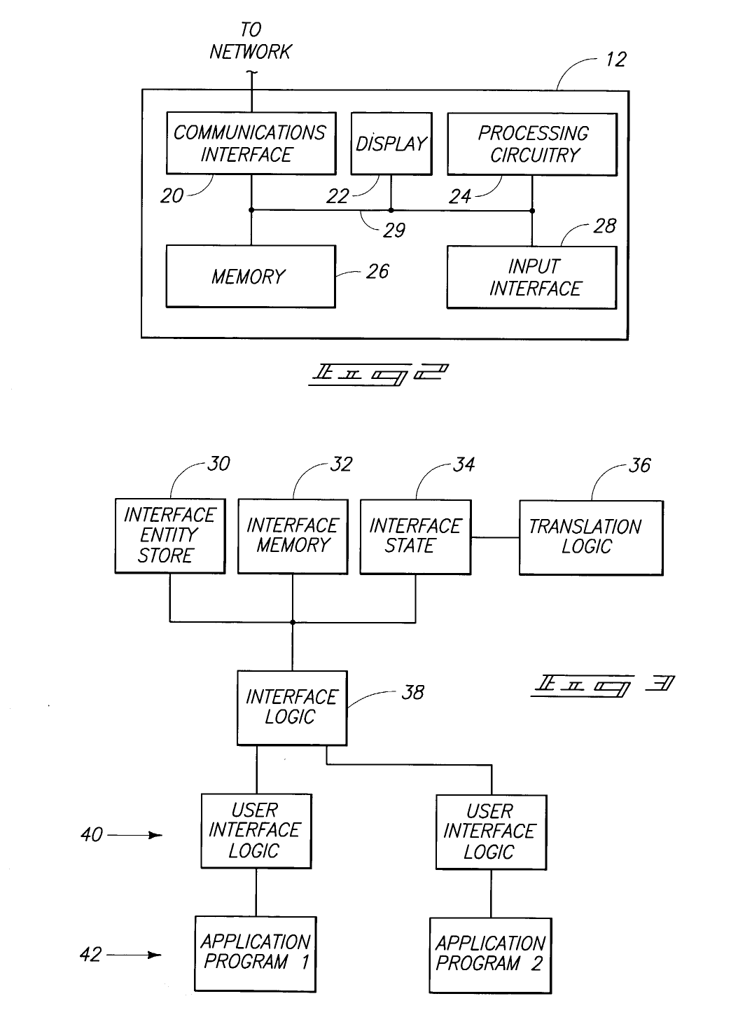

Referring to FIG. 2, an exemplary configuration of processing device 12 corresponding to host device 16 or client device 18 is shown. The depicted exemplary processing device 12 includes a communications interface 20, a display 22, processing circuitry 24, memory 26 and an input interface 28. A bus 29 is implemented to provide bi-directional communications between the respective components of processing device 12.

Communications interface 20 is arranged to couple with communications medium 14 to implement bi-directional communications with respect to external devices, such a remote processing device 12. Communications interface 20 may be implemented as a network interface card (NIC) or modem in exemplary embodiments.

Display 22 is arranged to convey visual information to a user. Display 22 may be implemented as a CRT monitor, thin film transistor display, liquid crystal display (LCD), or other appropriate structure capable of depicting user interfaces to a respective user.

Processing circuitry 24 is configured to execute software, firmware or other appropriate instructions to implement desired processing operations and to control operations of processing device 12, such as controlling communications with respect to the other processing device 12. Processing circuitry 24 may be implemented in different embodiments corresponding to the configurations of the associated processing devices 12 in which the processing circuitry 24 is utilized. For example, processing circuitry 24 may comprise a microprocessor available from Intel Corporation, Advanced Micro Devices, Inc., or Motorola, Inc., or a dedicated microcontroller, or other configuration capable of executing instructions to control operations of processing device 12.

Memory 26 is arranged to store digital data, and code or instructions executable by processing circuitry 24. Exemplary memory 26 is implemented as random access memory (RAM), read only memory (ROM), flash memory, etc. Memory 26 may also include a mass storage device arranged to store executable code and data.

Input interface 28 is arranged to receive user actions for controlling operations of processing device 12, for inputting data, etc. Exemplary input interfaces 28 include a keyboard, mouse, joystick, or other structure capable of receiving actions from a user.

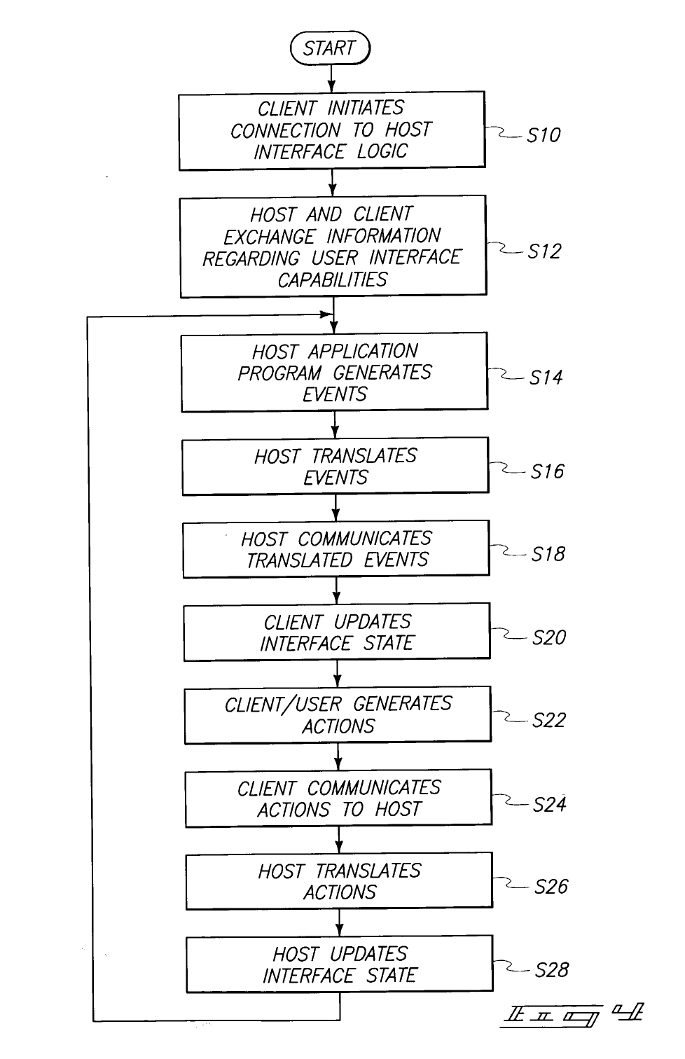

FIG. 3 is a system diagram depicting an exemplary arrangement of stored data or code executable by processing circuitry 24 of programming device 12. The illustrated system diagram may correspond to arrangements of host device 16 or client device 18. The exemplary system diagram includes an interface entity store 30, interface memory 32, interface state 34, translation logic 36, interface logic 38, user interface logic 40 and application programs 42. Other arrangements are possible.

Interface entity store 30 may be referred to as a compilation or library of a plurality of interface entities (e.g., visible interface elements) usable to generate a respective user interface depicted, for example, using display 22. Interface entities comprising visible interface elements may be stored as bitmap files within interface entity store 30 in one exemplary arrangement. Further, representation formats, such as SVG, could be used as internal representations for interface entities and identified interface entities could be provided within the user interface at runtime.

According to one described configuration, interface entities are stored within interface entity store 30 implemented as a non-volatile memory module of memory 26. The interface entity store 30 also includes a plurality of identifiers associated with and utilized to identify respective interface entities stored within the interface element store 30. Processing circuitry 24 may select, address and/or extract appropriate interface entities using appropriate identifiers.

Interface memory 32 includes mapping or addressing to locations of bitmaps or other representations of the interface entities within memory 26 and utilized to form user interfaces to be depicted using display 22.

Interface state 34 provides a current state of the user interface being depicted using display 22. For example, interface state 34 may include high level representations of the interface entities and indicate which entities are active, hidden, etc. at different moments in time during the presentation of the user interfaces.

Translation logic 36 provides handshaking operations with respect to other programming devices 12. For example, translation logic 36 provides negotiation and mapping of interface entities between the respective processing devices 12. The mapping and negotiation operations are performed to provide association of different interface entities between processing devices 12 and sharing of interface entities between processing devices 12 as mentioned above. Additional details of translation logic 36 are described below.

In one embodiment, translation logic 36 of host device 16 implements desired negotiation and mapping and translation logic 36 of client device 18 may be omitted. According to other aspects, translation logic 36 of client device 18 may be utilized to implement translation functionality alone or in addition to translation logic 36 of host device 16. For example, translation logic 36 may be utilized within client device 18 to provide translation of actions, events or identifiers prior to communications to host device 16 or following receipt of actions, events or identifiers from host device 16.

Interface logic 38 interfaces with one or more user interface logic 40 corresponding to one or more application program 42 being executed at a particular moment in time. Interface logic 38 provides operations for controlling user interfaces including for example, positioning of windows, closing of windows, display of pointer or mouse operations, etc.

User interface logic 40 provides interfacing logic to make calls to operating system libraries and appropriate operations between the application, programs 42 and the interface logic 38.

As shown, one or a plurality of application programs 42 may be active in a processing device 12 at a given moment in time. For embodiments wherein processing device 12 comprises a host, the illustrated application programs 42 of FIG. 3 represent execution of one or more application program 42 by the host device 16. For arrangements wherein processing device 12 is a client, user interface logic 40 and application programs 42 correspond to the executed application programs of the host device 16 and which are represented by a user interface of the client. Application programs 42 may include any appropriate program code usable within the processing devices 12.

Aspects of the invention provide translation of a user interface of a host device 16 to a user interface of a client device 18. Interface entities of a host user interface (e.g., what the user sees, what the user can do, etc.) are converted to corresponding interface entities for use in a user interface depicted using client device 18. The translation operations of the present invention provide flexibility to depict information via a plurality of user interfaces of processing devices 12 which may be executing similar or different operating systems, have different hardware configurations or capabilities of displays 22, etc.

For example, a client device 18 having two-dimensional display capabilities may remotely present a user interface (i.e., in 2-D space) corresponding to a user interface depicted in three-dimensional space using host device 16. According to aspects of the invention, translation logic 36 provides negotiation or mapping between interface entities of host device 16 and client device 18. Accordingly, a client device 18 running a different operating system or having a different user interface than host device 16 may present an appropriate user interface corresponding to an application program executed upon, host device 16 and/or corresponding to a user interface depicted using host device 16.

Referring to FIG. 4, exemplary mapping or negotiation operations with respect to interface entities are described according to one possible methodology for sharing an application program within a plurality of processing devices 12. Processing circuitry 24 of host device 16 and client device 18 are arranged to execute appropriate instructions (e.g., translation logic, interface logic) to implement the depicted exemplary aspects of the invention.

Initially, at a step S10, a client device initiates a communications connection to the interface logic of a host device.

At a step S12, appropriate interface logic of the host device and the client device exchange information regarding user interface capabilities. The exchange may include comparing the compilations or libraries of interface entities of the respective processing devices with one another.

The negotiation between the respective interface logic results in a mapping of interface entities between the respective interface entity stores of the respective devices. The mapping may associate the same or similar interface entities of the plural compilations when possible. In addition, the mapping may associate different interface entities to assure that functionality or expressions of one user interface are appropriately presented using the other user interface.

In addition, from the negotiation (e.g., comparison of the compilations of the interface entities of devices 16, 18), it might be determined that one of the processing devices may not have a respective interface entity which corresponds to or may otherwise be associated with the interface entity of the other processing device. For example, a large majority of interface entities may be preloaded in a client device but the client device may lack updated interface entities. The corresponding host device may share one or more interface entity with the client device along with appropriate respective identifier(s) of the shared interface entities. Shared interface entities may include, for example, new icons, window types, scrolling mechanisms, etc. Following the sharing of the interface entities, the processing devices may communicate respective identifiers to identify, modify or otherwise utilize the shared interface entities as opposed to communicating the entire; interface entities in real time. A client device may also share interface entities with a host device if appropriate.

At a step S14, execution of an application program within the host device may generate events. Generated events may be expressed in terms of the interface state of the host device and depicted, if appropriate, using the user interface of the host device.

At a step S16, the host device translates the events into events usable by the client device and may identify identifiers for affected interface entities of the client device in accordance with the mapping and negotiation of step S12.

At a step S18, the host device communicates translated events and appropriate identifiers to the client device.

At a step S20, the client device updates the client interface state which results in corresponding changes to the respective user interface (e.g., including any changes to one or more interface entity identified by the communicated identifiers) depicted using the client device.

At a step S22, the client device receives user input (e.g., user pressing a button, or other input of the input interface) or otherwise generates an action.

At a step S24, the client device communicates the generated actions to the host device along with an identifier, if appropriate.

At a step S26, the translation logic of the host device translates received actions and identifiers from the client device to identify the appropriate interface entities of the host device user interface and to implement any appropriate modifications to the respective user interface responsive to the actions of the client device.

At a step S28, the host device updates the host interface state resulting in the change of the user interface being depicted using the display.

The depicted methodology may be repeated to provide updates for occurring events, actions or other changes to the user interfaces.

Accordingly, in exemplary implementations of the invention, interface entities may be shared between processing devices 12. Host device 16 may provide translation of a host interface entity to be shared and communicate the translated interface entity to client device 18 for storage within the interface entity store 30 of client device memory 26 along with an appropriate identifier. Alternatively, host device 16 may receive one or more shared interface entity from client device 18, provide appropriate translation, and thereafter store the translated one or more interface entity within the interface entity store 30 of host device 16 along with an appropriate identifier.

Changes to respective user interfaces depicted using respective displays 22 of host device 16 and client device 18 may be communicated using appropriate identifies as opposed to communicating the interface entities themselves between host device 16 and client device 18. For example, in step S18, the host device 16 may identify an appropriate interface entity of client device 18 to be changed responsive to a change to the respective interface entity of host device 16. The host device 16 may perform appropriate translation operations upon the identified interface entity which provides an identifier of the corresponding translated interface entity of the client device 18. The host device 16 may communicate the identifier and appropriate event or action operation (e.g., close windows, move window, etc.) for modifying the identified interface entity. Client device 18 operates to provide the update to the user interface of the client device 18 including the modification to the identified interface entity. Similarly, client device 18 may communicate events and/or actions and respective identifiers of interface entities which are to be changed or modified to host device 16 as opposed to communicating an entirety of the interface entity. The host device 16 may translate the received identifier and operate to modify the appropriate interface entity of the user interface responsive to the change or modification.

Aspects of the invention provide translation of a user interface from one device to another device. Actions and events which affect the user interfaces are communicated between the communicating devices. For example, a change to the user interface of host device 16 (e.g., a dialog box popping up with a message “Play All Songs?”) could be communicated to client device 18 as an identifier of the interface entity (i.e., dialog box), coordinates of the dialog box and appropriate text strings. These exemplary communications utilize a few bytes to deliver user interface changes as opposed to thousands of bytes utilized to send bitmaps of a dialog box or an entire screen. Further, updates or alterations to user interfaces (e.g., installing new user interface skins) may be accomplished by downloading into client device 18 the appropriate revised interface entities which were upgraded or revised in the user interface of host device 16.

According to exemplary aspects of the present invention, faster communications of user interaction sessions between host device 16 and client device 18 are provided. Low-bandwidth communications of desktop-resolution user interfaces is provided using identifiers and interface entity updates. The low-bandwidth communications permit usage of other available bandwidth for other data, such as audio, video, text, etc. Additionally, upgraded look and feel of the user interfaces of host device 16 and/or client device 18 are possible with minimal use of available bandwidth.

The protection sought is not to be limited to the disclosed embodiments which are given by way of example only, but instead is to be limited only by the scope of the appended claims.

What is claimed is:

1. An application program sharing system comprising:
a host device configured to execute an application program and to depict a first user interface according to a first compilation of a plurality of first interface entities to convey information regarding the execution of the application program;
a client device configured to communicate with the host device and to depict a second user interface according to a second compilation of a plurality of second interface entities different than at least some of the first interface entities of the first compilation, and wherein the client device is configured to depict the second user interface to convey information regarding the execution of the application program by the host device; and
wherein at least one of the host device and the client device is configured to associate one of the first interface entities with one of the second interface entities, and the associated one of the first user interface entities and the associated one of the second user interface entities comprise different user interface entities.

2. The system of claim 1 wherein the associated one of the first interface entities and the associated one of the second interface entities comprise actions of a user with respect to respective ones of the host device and the client device.

3. The system of claim 1 wherein the associated one of the first interface entities and the associated one of the second interface entities comprise events which result in a change of the first user interface and the second user interface.

4. The system of claim 1 wherein the associated one of the first interface entities and the associated one of the second interface entities comprise user interface elements.

5. The system of claim 1 wherein one of the host device and the client device is configured to share a respective one of the first and the second interface entities with the other of the host device and the client device.

6. The system of claim 5 wherein the one of the host device and the client device is configured to share the respective one of the first and the second interface entities responsive to a comparison of the first interface entities and the second interface entities.

7. The system of claim 5 wherein the other of the host device and the client device is configured to depict the respective one of the first user interface and the second user interface according to the shared one of the first and the second interface entities.

8. The system of claim 1 wherein the host device comprises a computer and the client device comprises a mobile appliance.

9. The system of claim 1 wherein the host device is configured to communicate a plurality of identifiers of second interface entities to the client device and the client device is configured to identify selected ones of the second interface entities using the identifiers and to depict the second user interface using the selected ones of the second interface entities.

10. The system of claim 9 wherein the host device is configured to translate a plurality of the first interface entities into the identifiers of the second interface entities.

11. A processing device configured to share an application program, the processing device comprising:
a communications interface adapted to couple with a remote device;
a display configured to depict a first user interface according to a plurality of first interface entities to communicate information to a user regarding an execution of an application program using one of the processing device and the remote device, and wherein the display depicts the-first user interface corresponding to a second user interface depicted using the remote device according to a plurality of second interface entities; and
processing circuitry configured to control communications with respect to the remote device, to associate one of the first interface entities with one of the second interface entities, and to control the display to depict the first user interface according to the associated one first interface entity.

12. The device of claim 11 wherein the processing circuitry is configured to perform host operations including execution of the application program.

13. The device of claim 11 wherein the processing circuitry is configured to perform client operations.

14. The device of claim 11 wherein the associated one of the first interface entities and the associated one of the second interface entities comprise actions of a user with respect to respective ones of the host device and the client device.

15. The device of claim 11 wherein the associated one of the first interface entities and the associated one of the second interface entities comprise events which result in a change of respective ones of the first user interface and the second user interface.

16. The device of claim 11 wherein the associated one of the first interface entities and the associated one of the second interface entities comprise user interface elements.

17. The device of claim 11 further comprising a memory, and wherein the processing circuitry is configured to store a first interface entity using the memory and corresponding to one of the second interface entities shared from the remote device.

18. The device of claim 11 wherein the processing circuitry is configured to share an interface entity corresponding to one of the first interface entities with the remote device.

19. The device of claim 18 wherein the processing circuitry is configured to share the interface entity responsive to a comparison of the first interface entities and the second interface entities.

20. The device of claim 18 wherein the processing circuitry is configured to control the display to depict the first user interface according to the one first interface entity.

21. The device of claim 11 wherein the processing circuitry is configured to select one of the first interface entities responsive to a received identifier from the remote device and to control the display to depict the first user interface according to the selected one of the first interface entities.

22. The device of claim 11 wherein the processing circuitry is configured to translate a plurality of the first interface entities into a plurality of identifiers of the second interface entities and to control communication of the identifiers to the remote device.

23. A processing device configured to share an application program, the processing device comprising:
interface means for communicating with a remote device;
display means for depicting a first user interface according to a plurality of first interface entities to communicate information to a user regarding an execution of an application program using one of the processing device and the remote device; and
processing means for accessing information regarding a plurality of second interface entities utilized by the remote device to depict a second user interface, for communicating an interface entity corresponding to one of the first interface entities and the second interface entities with respect to the remote device and responsive to the accessing of the information, and for controlling the display means to depict the first user interface according to the communicated interface entity.

24. The method of claim 23 wherein the processing means for communicating the interface entity comprises means for controlling the interface means to output the communicated interface entity to the remote device.

25. The method of claim 23 wherein the processing means for communicating the interface entity comprises means for receiving the communicated interface entity from the remote device.

26. The method of claim 23 wherein the processing means comprises means for associating one of the first interface entities with one of the second interface entities, and the associated first and second user interface entities comprise different interface entities.

27. The method of claim 23 wherein the processing means comprises means for comparing the first interface entities and the second interface entities, and the communicating is responsive to the comparing.

28. The method of claim 23 wherein the processing means comprises means for communicating a plurality of identifiers for the first interface entities.

29. The method of claim 23 wherein the processing means comprises means for translating the first interface entities to a plurality of identifiers and for communicating the identifiers to the remote device.

30. The method of claim 23 wherein one of the processing means and the remote device comprises means for executing the application program and the other of the processing means and the remote device comprises means for implementing client operations.

31. An application program sharing method comprising:
providing a processing device having a first compilation of a plurality of first interface entities;
executing the application program using the processing device;
sharing the execution of the application program with a remote device having a second compilation of a plurality of second interface entities;
associating one of the second interface entities with one of the first interface entities, and wherein the associated first and second interface entities comprise different interface entities; and
depicting a user interface using the processing device to convey information regarding the execution of the application program and according to the first interface entities including the associated one of the first interface entities.

32. The method of claim 31 wherein at least some of the first interface entities and the second interface entities comprise actions with respect to respective ones of the processing device and the remote device.

33. The method of claim 31 wherein at least some of the first interface entities and the second interface entities comprise events with respect to respective ones of the processing device and the remote device.

34. The method of claim 31 wherein at least some of the first interface entities and the second interface entities comprise user interface elements.

35. The method of claim 31 further comprising sharing one of the first and the second interface entities of one of the processing device and the remote device with the other of the processing device and the remote device.

36. The method of claim 31 further comprising:
receiving an identifier from the remote device; and
translating the identifier into a first interface entity, and wherein the displaying comprises displaying the user interface according to the translated first interface entity.

37. The method of claim 31 further comprising:
translating the first interface entities into a plurality of identifiers; and
communicating the identifiers to the remote device.

38. The method of claim 31 further comprising receiving a plurality of identifiers, and the displaying comprises displaying according to a plurality of the second interface entities identified by the identifiers.

39. The method of claim 31 wherein the providing comprises providing a host device.

40. The method of claim 31 wherein the providing comprises providing a client device.

41. An application program sharing method comprising:
providing a host device including a first compilation of a plurality of first interface entities;
providing a client device including a second compilation of a plurality of second interface entities different than the first interface entities;
providing information regarding the contents of the first compilation of the first interface entities and the second compilation of the second interface entities;
sharing one of the first and the second interface entities of one of the host device and the client device with the other of the host device and the client device after the providing the information; and
depicting a plurality of user interfaces using the host device and the client device and according to respective ones of the first and the second interface entities corresponding to the shared one of the interface entities.

42. The method of claim 41 further comprising:
executing an application program using the host device; and
depicting information related to the execution of the application program using the client device.

43. The method of claim 41 further comprising comparing the first compilation and the second compilation, and wherein the sharing is responsive to the comparing.

44. The method of claim 41 further comprising associating one of the first interface entities with one of the second interface entities different than the one first interface entity, and wherein the depicting comprises depicting the user interfaces according to respective ones of the associated first and second interface entities.

45. The method of claim 41 further comprising:
communicating a plurality of identifiers between the host device and the client device; and
selecting ones of the first interface entities and ones of the second interface entities responsive to the identifiers, and wherein the depicting comprises depicting the user interfaces according to respective selected ones of the first interface entities and the second interface entities.

46. The method of claim 41 further comprising:
translating the first interface entities into a plurality of identifiers of the second interface entities using the host device; and
communicating the identifiers from the host device to the client device, and wherein the depicting the user interface using the client device comprises depicting according to the second interface entities identified by the identifiers.

47. The method of claim 41 further comprising:
communicating a plurality of identifiers of the second interface entities from the client device to the host device; and
identifying the first interface entities responsive to the identifiers and using the host device, and wherein the depicting the user interface using the host device comprises depicting after the identifying.
